(19) United States
(12) Patent Application Publication
(10) Pub. No.: US 2025/0327537 A1
(43) Pub. Date: Oct. 23, 2025

(54) CORRUGATED TUBULAR MEMBER AND METHOD FOR PRODUCING CORRUGATED TUBULAR MEMBER

(71) Applicant: TOYODA GOSEI CO., LTD., Kiyosu-shi (JP)

(72) Inventors: Kazutoshi MIYAKE, Kiyosu-shi (JP); Kenichiro KANEKO, Kiyosu-shi (JP)

(21) Appl. No.: 19/085,519

(22) Filed: Mar. 20, 2025

(30) Foreign Application Priority Data
Apr. 19, 2024 (JP) 2024-068608

(51) Int. Cl. F16L 11/15; B29C 44/24; B29K 21/00; B29K 23/00; B29L 23/00; B32B 1/08; B32B 3/30; B32B 5/20; B32B 27/06; B32B 27/32

(52) U.S. Cl. CPC F16L 11/15; B29C 44/24; B32B 1/08; B32B 3/30; B32B 5/20; B32B 27/065; B32B 27/32; B29K 2021/003; B29K 2023/12; B29L 2023/005; B32B 2266/0292; B32B 2307/7375; B32B 2597/00

(57) ABSTRACT

A corrugated tubular member 1 has a corrugated surface shape on an outer circumferential surface 2. At least a part of the corrugated tubular member 1 in a radial direction is formed as a foamed layer 4. The entirety of the corrugated tubular member 1 including the outer circumferential surface 2 and an inner circumferential surface 3 in a thickness direction is integrally molded. The corrugated tubular member 1 satisfies the following (a) or (b). (a) The corrugated surface shape is formed on the inner circumferential surface 3 in addition to the outer circumferential surface 2, and 3L<2L is satisfied. (b) The inner circumferential surface 3 does not have the corrugated surface shape.

### TECHNICAL FIELD

The present disclosure relates to a corrugated tubular member as a kind of a tubular member, and a method for producing the corrugated tubular member.

### BACKGROUND ART

To date, tubular members used in various applications have been known (for example, see JP2022-51513A).

For example, a coolant tube for connecting a heat exchanger to a liquid feeding pump or a tank is known as a tubular member mounted to a vehicle. The tube inside of the coolant tube as a tubular member functions as a coolant flow path through which a coolant for a vehicle flows.

This type of the tubular member needs to have a shape and a length corresponding to a positional relationship between devices to be connected, for example, corresponding to the heat exchanger, and a positional relationship between the liquid feeding pump and the heat exchanger as described above.

However, the positional relationship between devices to be connected varies according to kinds of the devices and combination of the devices, an environment in which the devices are disposed, and the like. Therefore, setting the shape and the length of the tubular member individually according to the positional relationship, etc., is not preferable in terms of cost. In a case where the tubular member is structured to be bendable and deformable, the shape and the length of the tubular member are varied, and versatility of the tubular member is considered to be enhanced.

As a bendable and deformable tubular member, a tubular member having, on the outer circumferential surface, a corrugated surface shape in which a recessed surface portion extending in the circumferential direction so as to be recessed inward in the radial direction, and a protruding surface portion extending in the circumferential direction so as to protrude outward in the radial direction alternate along the axial direction, is known. This type of tubular member is deformed so as to have various shapes and various lengths by allowing the adjacent protruding surface portions (or recessed surface portions) to be close to each other and apart from each other.

In the present specification, this type of tubular member is called corrugated tubular member.

### SUMMARY OF INVENTION

### Technical Problem

In general, a corrugated tubular member has the above-described corrugated surface shape on both the outer circumferential surface and the inner circumferential surface. In the corrugated tubular member, since a fluid flowing inside the tube is exposed to the corrugated surface shape on the inner circumferential surface, pressure loss tends to be increased.

JP2022-51513A describes a tubular member having a double-tube structure in which a straight-tube-shaped inner tube is covered with a cover tube as a corrugated tubular member, as a tubular member for supplying water and hot water. In a case where the inner circumferential surface of the corrugated tubular member is formed in a straight-tube like shape as in the tubular member, the tubular member is structured to be bendable and deformable, and is also likely to inhibit increase of pressure loss.

However, in order to produce the corrugated tubular member having the double-tube structure as described in JP2022-51513A, a special molding machine for molding a straight-tube-shaped inner tube and also molding a cover tube having a corrugated surface shape on the outer circumferential surface of the inner tube, needs to be used. Therefore, the corrugated tubular member having the double-tube structure has a problem that production cost is high.

The present disclosure has been made in view of the aforementioned circumstances, and an object of the present disclosure is to provide a technique for producing a corrugated tubular member that inhibits increase of pressure loss at low cost.

### Solution to Problem

A corrugated tubular member of the present disclosure for solving the aforementioned problem is directed to a corrugated tubular member that includes a tubular member having a tubular shape, the tubular member being elastically bendable and deformable, in which
a corrugated surface shape in which a recessed surface portion extending in a circumferential direction so as to be recessed inward in a radial direction, and a protruding surface portion extending in the circumferential direction so as to protrude outward in the radial direction alternate along an axial direction is formed on an outer circumferential surface,
at least a part of the corrugated tubular member in the radial direction is formed as a foamed layer,
an entirety of the corrugated tubular member including the outer circumferential surface and an inner circumferential surface in a thickness direction is integrally molded, and
the following element (a) or (b) is satisfied,
(a) the corrugated surface shape is formed also on the inner circumferential surface in addition to the outer circumferential surface, and
a difference between a recess and a protrusion in the radial direction in the corrugated surface shape on the inner circumferential surface is less than a difference between a recess and a protrusion in the radial direction in the corrugated surface shape on the outer circumferential surface, or
(b) the inner circumferential surface does not have the corrugated surface shape.

A method for producing a corrugated tubular member according to the present disclosure for solving the aforementioned problem is directed to a method for producing the above-described corrugated tubular member of the present disclosure, and the method includes a molding step of molding a foam tube material having a straight tube shape from an outer circumferential surface side by a mold block of a corrugator, and forming the corrugated surface shape on the outer circumferential surface of the foam tube material.

The corrugated tubular member and the method for producing the corrugated tubular member according to the present disclosure allow a corrugated tubular member that inhibits increase of pressure loss to be produced at low cost.

### BRIEF DESCRIPTION OF DRAWINGS

FIG. 1 schematically illustrates a corrugated tubular member of Embodiment 1;

FIG. 2 schematically illustrates a cross section of the corrugated tubular member of Embodiment 1;

FIG. 3 schematically illustrates a method for producing the corrugated tubular member according to Embodiment 1; and

FIG. 4 schematically illustrates a cross-section of a corrugated tubular member of Embodiment 2.

### DESCRIPTION OF EMBODIMENTS

A corrugated tubular member and a method for producing the corrugated tubular member according to the present disclosure will be described below by way of specific examples.

The corrugated tubular member of the present disclosure is a tubular member that has a tubular shape and is elastically bendable and deformable. In other words, the corrugated tubular member of the present disclosure has such flexibility as to be compressively deformed and freely bendable by an external force applied in the radial direction.

An inside of a tube of the corrugated tubular member of the present disclosure functions as a fluid flow path.

The corrugated tubular member of the present disclosure is structured to have, on an outer circumferential surface, a corrugated surface shape in which a recessed surface portion extending in the circumferential direction so as to be recessed inward in the radial direction, and a protruding surface portion extending in the circumferential direction so as to protrude outward in the radial direction alternate along the axial direction, and at least a part of the corrugated tubular member in the radial direction is formed as a foamed layer. Thus, the corrugated tubular member of the present disclosure is elastically bendable and deformable.

The corrugated tubular member of the present disclosure satisfies the following element (a) or (b).
(a) The corrugated surface shape is formed also on an inner circumferential surface in addition to the outer circumferential surface, and
a difference between the recess and the protrusion in the radial direction in the corrugated surface shape on the inner circumferential surface is less than a difference between the recess and the protrusion in the radial direction in the corrugated surface shape on the outer circumferential surface, or
(b) the inner circumferential surface does not have the corrugated surface shape.

In a case where the corrugated tubular member of the present disclosure satisfies the element (a), the difference between the recess and the protrusion in the radial direction in the corrugated surface shape on the inner circumferential surface is less than the difference between the recess and the protrusion in the radial direction in the corrugated surface shape on the outer circumferential surface. Therefore, the corrugated tubular member has the corrugated surface shape while pressure loss of a fluid inside the tube, i.e., increase of pressure loss, is inhibited.

In a case where the corrugated tubular member of the present disclosure satisfies the element (b), the inner circumferential surface does not have the corrugated surface shape. Therefore, in the corrugated tubular member, pressure loss itself due to the corrugated surface shape does not occur.

Furthermore, the entirety of the corrugated tubular member of the present disclosure including the outer circumferential surface and the inner circumferential surface in the thickness direction is integrally molded. Therefore, unlike the corrugated tubular member having the double-tube structure as described above in JP2022-51513A in which a straight-tube-shaped inner tube is molded and a cover tube having a corrugated surface shape is also molded on the outer circumferential side of the inner tube, a special molding machine need not be used.

Accordingly, the corrugated tubular member of the present disclosure allows a corrugated tubular member that inhibits increase of pressure loss to be produced at low cost.

The corrugated tubular member according to the present disclosure and the method for producing the corrugated tubular member according to the present disclosure will be described below for each of the constituents.

Hereinafter, unless otherwise specified, the production method of the present disclosure refers to the method for producing the corrugated tubular member according to the present disclosure.

Furthermore, unless otherwise specified, the circumferential direction, the radial direction, and the axial direction refer to the circumferential direction, the radial direction, and the axial direction, respectively, of the corrugated tubular member of the present disclosure.

Unless otherwise specified, a numerical value range “x to y” described herein includes a lower limit “x” and an upper limit “y” in the range. A numerical value range may be formed by discretionarily combining such an upper limit value and a lower limit value, and numerical values described in the embodiment. Furthermore, numerical values selected discretionarily from the numerical value range may be used as the upper limit value and lower limit value.

The corrugated tubular member of the present disclosure may be any corrugated tubular member that allows a fluid to flow inside the tube, and is not limited to a tube for a coolant for a vehicle as described above.

The fluid flowing in the flow path may be either liquid or gas.

At least a part of the corrugated tubular member of the present disclosure in the radial direction is formed as a foamed layer. The foamed layer may form the outer circumferential surface, may form the inner circumferential surface, or may be formed between the outer circumferential surface and the inner circumferential surface, in the corrugated tubular member. Since a fluid flows inside the tube of the corrugated tubular member, the foamed layer is preferably disposed closer to the outer circumferential surface than to the inner circumferential surface in the radial direction of the corrugated tubular member, and, more preferably, the corrugated tubular member has a non-foamed solid layer on the inner side of the foamed layer in the radial direction.

In a case where the corrugated tubular member of the present disclosure has the foamed layer and the solid layer, the inner circumferential surface of the corrugated tubular member is preferably formed as the solid layer.

The corrugated tubular member of the present disclosure is elastically bendable and deformable. Therefore, as a material of the foamed layer, an elastically deformable material needs to be selected. In a case where the corrugated tubular member of the present disclosure has the above-described solid layer in addition to the foamed layer, an elastically deformable material needs to be selected also as a material of the solid layer.

The material of the foamed layer is not particularly limited as long as the material of the foamed layer is elastically bendable and deformable, but a material in which pores are dispersed and disposed in a matrix such as a resin, rubber, or an elastomer is preferable. The porosity of the foamed layer and the size of the pore are not particularly limited. Furthermore, each pore in the foamed layer may be independently formed, or at least a part of the pores may be continuous. In other words, the foamed layer may be either a closed-cell-type foamed layer or an open-cell-type foamed layer.

A gas, a liquid, or a solid different from the material forming the matrix of the foamed layer may be put in the pore of the foamed layer.

The matrix of the foamed layer preferably contains a thermoplastic elastomer. Examples of the thermoplastic elastomer used for the foamed layer include a thermoplastic vulcanized elastomer (TPV: thermoplastic vulcanizates), an olefin-based thermoplastic elastomer (TPO: thermoplastic olefinic elastomer), and a styrene-based thermoplastic elastomer (TPS: thermoplastic styrenic elastomer). Among them, TPV is particularly preferably used.

As the material of the solid layer, a resin, rubber, or an elastomer is preferably used. Specific examples of the material used preferably for the solid layer include polypropylene (PP), polyphenylene sulfide (PPS), and polyamide (PA) in addition to various thermoplastic elastomers described above.

The solid layer is intended to be a non-foamed layer, but is also allowed to be a slightly foamed layer. The reason is as follows. That is, when a foam tube material is produced as a material of the corrugated tubular member of the present disclosure, or when the corrugated tubular member of the present disclosure is molded, a foaming agent, foam beads, or the like as the material of the foamed layer may be mixed into the material of the solid layer, and the solid layer is likely to be slightly foamed due to the mixture.

The expansion ratio of the solid layer is one-third or less, one-fifth or less, or one-eighth or less of the expansion ratio of the foamed layer, in the foaming.

The foamed layer may be either a monolayer or a multilayer. For example, a protective layer may be formed on the outer side of the foamed layer in the radial direction. The protective layer may be either a foamed layer having pores or a non-foamed solid layer having no pores.

The protective layer may be either a monolayer or a multilayer having two or more layers.

The protective layer is, for example, preferably at least one of a layer having a higher strength than the foamed layer, a layer having more excellent weather resistance than the foamed layer, and a layer having more excellent heat resistance than the foamed layer.

The material, the structure, and the like of the protective layer are not particularly limited as long as the foamed layer is reinforced by the protective layer. However, the porosity of the protective layer is preferably lower than the porosity of the foamed layer. Specifically, the porosity of the protective layer is preferably less than 20%.

The protective layer may cover the entirety of the surface of the foamed layer from the outer side, or may cover merely a part of the surface of the foamed layer from the outer side. In order to protect the foamed layer by the protective layer with high reliability, the protective layer more preferably covers a wide portion of the surface of the foamed layer.

Specifically, in a case where the surface area of the foamed layer is 100%, the protective layer preferably covers 60% or more of the surface area, more preferably covers 70% or more of the surface area, and particularly preferably covers 80% or more of the surface area. Here, the surface area of the foamed layer refers to an apparent surface area calculated on the assumption that the foamed layer has no pores.

In a case where the protective layer is a foamed layer, a material forming a matrix of the protective layer may be the same as the material of the foamed layer, or a material different from the material of the foamed layer.

In a case where the protective layer is a non-foamed layer, a material of the protective layer may be the same as the material of the solid layer, or a material different from the material of the solid layer.

A layer called a skin layer having a low porosity is formed on the surface of the foamed layer in some cases. The skin layer is formed when the foamed layer is formed, and is formed by quickly cooling a portion of the molding material in contact with a surface of a mold.

The skin layer is formed of the same material as the foamed layer, and is formed integrally with the foamed layer. The skin layer is laminar, has a lower porosity than the other portions of the foamed layer as described above, and is distinguishable from the solid layer since the skin layer is very thin.

Specifically, the thickness of the skin layer is considered to be 1 mm or less. In a case where the corrugated tubular member of the present disclosure has the solid layer, the thickness of the solid layer is preferably one-tenth or more, one-fifth or more, or two-fifths or more of the thickness of the foamed layer. In other words, the thicknesses of the solid layer and the foamed layer are lengths of the solid layer and the foamed layer in the radial direction.

As the material of each of the foamed layer and the solid layer, one of the various materials may be used alone, or some of the various materials may be used in combination.

Furthermore, as the material of each of the foamed layer and the solid layer, a material obtained by using one or more selected from various resins, rubbers, and elastomers as a base material, and adding a filler such as a metal or glass to the base material, is also suitably used. In this case, various functionalities derived from the filler are imparted to the foamed layer and the solid layer.

The corrugated tubular member of the present disclosure has, on the outer circumferential surface, the corrugated surface shape in which the recessed surface portion and the protruding surface portion alternate along the axial direction. The recessed surface portion extends in the circumferential direction so as to be recessed inward in the radial direction. The protruding surface portion extends in the circumferential direction so as to protrude outward in the radial direction.

The corrugated surface shape is considered to have a plurality of the recessed surface portions and at least one protruding surface portion or have a plurality of the protruding surface portions and at least one recessed surface portion.

The corrugated tubular member of the present disclosure may have the corrugated surface shape on the entirety of the outer circumferential surface, or on merely a part of the outer circumferential surface in the axial direction. For example, both end portions of the corrugated tubular member of the present disclosure in the axial direction may be formed in a straight tube shape having no corrugated surface shape on the outer circumferential surface.

The recessed depth of the recessed surface portion may be uniform or non-uniform in the circumferential direction. Similarly, the protruding height of the protruding surface portion may be uniform or non-uniform in the circumferential direction.

Hereinafter, as necessary, a portion of the recessed surface portion positioned on the innermost side in the radial direction will be referred to as bottom of the recessed surface portion, and a portion of the protruding surface portion positioned on the outermost side in the radial direction will be referred to as top portion of the protruding surface portion.

Since the recessed surface portion extends in the circumferential direction, the bottom of the recessed surface portion also extends in the circumferential direction. Similarly, since the protruding surface portion extends in the circumferential direction, the top portion of the protruding surface portion also extends in the circumferential direction.

The corrugated tubular member of the present disclosure is a so-called corrugated tube, and preferable examples of a method for producing the corrugated tubular member of the present disclosure include the production method of the present disclosure as described below.

In a molding step of the production method of the present disclosure, the outer circumferential surface of the corrugated tubular member is basically molded. In a case where the corrugated tubular member is produced by such a production method, each of the protruding surface portion and the recessed surface portion is preferably continuous over the entire circumference in the circumferential direction, and the adjacent protruding surface portions are preferably separated and the adjacent recessed surface portions are preferably separated, in the axial direction, from the viewpoint of moldability.

Therefore, in the corrugated tubular member of the present disclosure, although the adjacent recessed surface portions may be helically continuous, the adjacent recessed surface portions are preferably separated from each other, from the viewpoint of moldability. Similarly, in the corrugated tubular member of the present disclosure, although the adjacent protruding surface portions may be helically continuous, the adjacent protruding surface portions are preferably separated from each other, from the viewpoint of moldability.

In a case where the corrugated surface shape has three or more recessed surface portions, a distance between the bottoms of the adjacent recessed surface portions may be constant or non-constant in the axial direction. In this case, the distance between the bottoms of the adjacent recessed surface portions may be constant or non-constant on the entire circumference of the corrugated tubular member.

Similarly, in a case where the corrugated surface shape has three or more protruding surface portions, a distance between the top portions of the adjacent protruding surface portions may be constant or non-constant in the axial direction. In this case, the distance between the top portions of the adjacent protruding surface portions may be constant or non-constant on the entire circumference of the corrugated tubular member.

The corrugated tubular member of the present disclosure may have the corrugated surface shape merely on the outer circumferential surface without having the corrugated surface shape on the inner circumferential surface, or may have the corrugated surface shape on each of the outer circumferential surface and the inner circumferential surface.

In a case where the corrugated tubular member of the present disclosure has the corrugated surface shape on each of the outer circumferential surface and the inner circumferential surface, the difference between the recess and the protrusion in the radial direction in the corrugated surface shape on the inner circumferential surface is less than the difference between the recess and the protrusion in the radial direction in the corrugated surface shape on the outer circumferential surface as described above for the element (a). The difference between the recess and the protrusion is considered to be a distance in the radial direction between the bottom of the recessed surface portion and the top portion of the protruding surface portion adjacent to the recessed surface portion.

Hereinafter, as necessary, the difference between the recess and the protrusion in the radial direction in the corrugated surface shape on the inner circumferential surface is referred to as difference between the recess and the protrusion on the inner surface, and the difference between the recess and the protrusion in the radial direction in the corrugated surface shape on the outer circumferential surface is referred to as difference between the recess and the protrusion on the outer surface, in some cases.

In the corrugated tubular member of the present disclosure, as long as the difference between the recess and the protrusion on the inner surface is less than the difference between the recess and the protrusion on the outer surface, the magnitudes of the difference between the recess and the protrusion on the outer surface and the difference between the recess and the protrusion on the inner surface, a ratio between the difference between the recess and the protrusion on the outer surface and the difference between the recess and the protrusion on the inner surface, etc., are not particularly limited. However, in order to reduce pressure loss of a fluid inside the tube, the difference between the recess and the protrusion on the inner surface is preferably small, and a smaller difference between the recess and the protrusion on the inner surface as compared with the difference between the recess and the protrusion on the outer surface is more preferable.

Specifically, the difference between the recess and the protrusion on the inner surface is, for example, preferably 0.75 mm or less, 0.5 mm or less, and 0.25 mm or less.

The difference between the recess and the protrusion on the outer surface does not have an influence on reduction of pressure loss. However, the difference between the recess and the protrusion on the outer surface is preferably great in order to freely bend and deform the tubular member. From such a viewpoint, the difference between the recess and the protrusion on the outer surface is, for example, preferably 0.75 mm or more, 1.0 mm or more, and 1.25 mm or more.

Furthermore, the difference between the recess and the protrusion on the inner surface is, for example, preferably three-fifths or less, half or less, and two-fifths or less of the difference between the recess and the protrusion on the outer surface.

As described above, the corrugated tubular member of the present disclosure is produced by the production method of the present disclosure.

The production method of the present disclosure includes a molding step. In the molding step, a foam tube material having a straight tube shape is molded from the outer circumferential surface side by a mold block of a corrugator, and the corrugated surface shape is formed on the outer circumferential surface of the foam tube material.

The foam tube material to be fed to the corrugator has a straight tube shape, and the foam tube material is formed of the material of the corrugated tubular member of the present disclosure. Specifically, the foam tube material may contain a material such as a resin, rubber, and an elastomer forming the matrix of the corrugated tubular member, a foaming agent that is foamed in the molding step, foam beads that expand the volume in the molding step, and the like.

The foam tube material has a straight tube shape, and is produced by a known method typified by extrusion molding or injection molding.

Here, the “straight tube shape” of the foam tube material represents a tubular shape which does not have a corrugated surface shape on the outer circumferential surface, and the cross-sectional shape and the axial shape are not particularly limited. For example, the foam tube material may have a round or a rectangular cross-sectional shape. The axial direction of the foam tube material may extend linearly, or may be curved or bent.

The foam tube material in a cured state may be fed to the corrugator or the foam tube material in an uncured state may be fed to the corrugator. For example, an extrusion molding machine for the foam tube material is disposed on the upstream side of the corrugator, and the foam tube material and the corrugated tubular member may be continuously produced.

The corrugator has a mold block for molding the outer circumferential surface of the foam tube material. The mold block has a mold surface for forming the corrugated surface shape, and two or more mold blocks are combined to form a cavity for surrounding the entire circumference of the outer circumferential surface of the foam tube material.

The corrugator has a pressure reducing device or a pressure applying device for pressing the foam tube material against the mold surface in the cavity. The pressure reducing device is a device for pressing the foam tube material against the mold surface in the cavity by reducing pressure in the cavity. The pressure applying device is a device for pressing the foam tube material against the mold surface in the cavity by supplying a fluid such as gas into the tube of the foam tube material disposed in the cavity.

In the molding step, the foam tube material is pressed against the mold surfaces of the mold blocks while increasing an apparent volume by foaming. Therefore, the corrugated surface shape along the mold surfaces is formed on the outer circumferential surface of the corrugated tubular member obtained in the molding step.

Meanwhile, the inner circumferential surface of the foam tube material is not molded in the molding step. Therefore, the inner circumferential surface of the corrugated tubular member obtained in the molding step has a so-called naturally formed shape corresponding to the corrugated surface shape of the outer circumferential surface.

In the corrugated tubular member obtained as above by the production method of the present disclosure, the difference between the recess and the protrusion on the inner surface is less than the difference between the recess and the protrusion on the outer surface. In order to reduce the difference between the recess and the protrusion on the inner surface as compared with the difference between the recess and the protrusion on the outer surface, a corrugator having a pressure reducing device instead of a pressure applying device is suitably used.

In order to reduce the difference between the recess and the protrusion on the inner surface as compared with the difference between the recess and the protrusion on the outer surface, the foam tube material may have a multilayer structure having two or more layers, and a layer disposed on the inner side in the radial direction may be a layer that is less likely to be deformed as compared with a layer disposed on the outer side in the radial direction.

In a case where the layer disposed on the inner side in the radial direction is less likely to be deformed as compared with the layer disposed on the outer side in the radial direction, the corrugated surface shape is unlikely to be formed on the inner circumferential surface of the foam tube material, so that the difference between the recess and the protrusion on the inner surface becomes less than the difference between the recess and the protrusion on the outer surface in the corrugated tubular member.

Specifically, a radially outer side portion of the foam tube material having the multilayer structure is preferably formed as a foam material layer, and a radially inner side portion of the foam tube material having the multilayer structure is preferably formed as a solid material layer. The foam material layer is a layer that is foamed in the molding step, and is a material of the foamed layer in the corrugated tubular member of the present disclosure. Meanwhile, the solid material layer is a layer that is not foamed or has a lower expansion ratio than the foamed layer in the molding step, and is a material of the solid layer in the corrugated tubular member of the present disclosure.

Furthermore, based on the findings of the inventor of the present disclosure, in a case where the expansion ratio of the foamed layer is high, the difference between the recess and the protrusion on the inner circumferential surface tends to be small and smooth.

Therefore, the expansion ratio of the foamed layer is preferably high. Specifically, the expansion ratio is, for example, preferably 1.3 times or more, 1.4 times or more, 1.5 times or more, and 1.6 times or more.

The corrugated tubular member and the method for producing the corrugated tubular member according to the present disclosure will be specifically described below by way of embodiments.

### Embodiment 1

A corrugated tubular member of Embodiment 1 is a coolant tube mounted to a vehicle. The corrugated tubular member of Embodiment 1 is produced by the production method of the present disclosure.

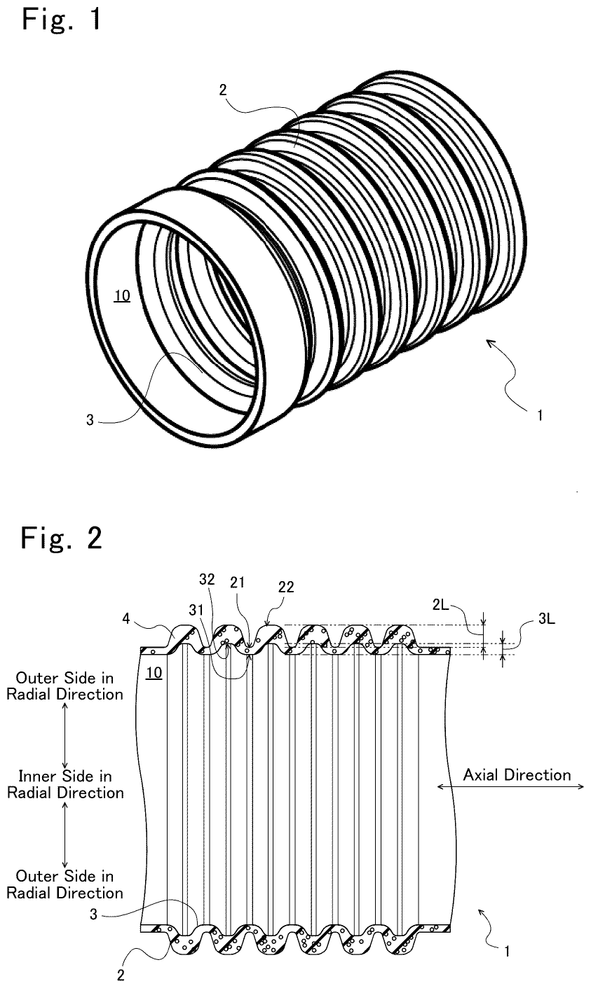

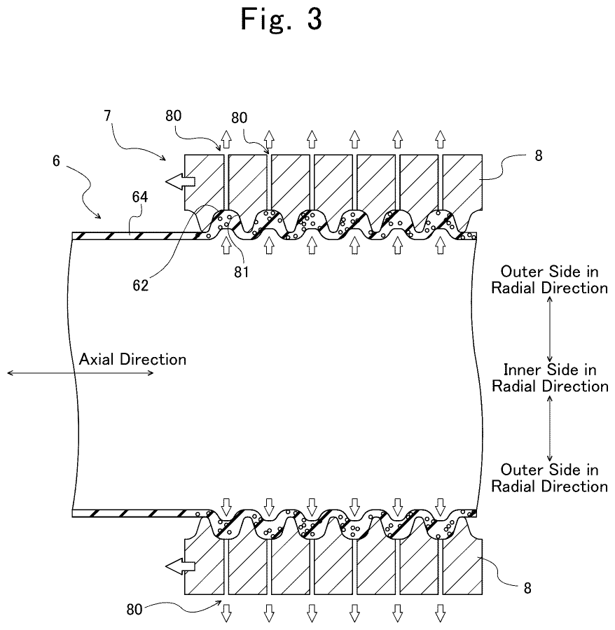

FIG. 1 schematically illustrates the corrugated tubular member of Embodiment 1. FIG. 2 schematically illustrates a cross section of the corrugated tubular member of Embodiment 1. FIG. 3 schematically illustrates a method for producing the corrugated tubular member according to Embodiment 1.

A corrugated tubular member 1 of Embodiment 1 is mounted to a not-illustrated vehicle, and forms a part of a flow path for a coolant for the vehicle.

As shown in FIG. 1, the corrugated tubular member 1 of Embodiment 1 has a substantially cylindrical shape. In the corrugated tubular member 1 of Embodiment 1, a corrugated surface shape is formed on each of an outer circumferential surface 2 and an inner circumferential surface 3.

As shown in FIG. 2, the corrugated tubular member 1 of Embodiment 1 has a monolayer structure formed merely of a foamed layer 4. The foamed layer 4 is formed of foamed TPV. Specifically, the matrix of the foamed layer 4 is formed of TPV that is a kind of a Thermo plastic elastomer. The foamed layer 4 is formed by using a mixed material of TPV pellets and a foaming agent as a raw material, and foam is formed in an extruding step and a molding step described below.

A tube inside 10 of the corrugated tubular member 1 is defined by the inner circumferential surface 3 of the corrugated tubular member 1, and functions as a flow path for a coolant for a vehicle.

The corrugated surface shape of the outer circumferential surface 2 of the corrugated tubular member 1 is formed such that a recessed surface portion extending in the circumferential direction so as to be recessed inward in the radial direction, and a protruding surface portion extending in the circumferential direction so as to protrude outward in the radial direction alternate along the axial direction. The recessed surface portion of the outer circumferential surface 2 is referred to as outer circumference recessed surface portion 21, and the protruding surface portion of the outer circumferential surface 2 is referred to as outer circumference protruding surface portion 22.

The corrugated surface shape of the inner circumferential surface 3 of the corrugated tubular member 1 is also formed such that a recessed surface portion extending in the circumferential direction so as to be recessed inward in the radial direction, and a protruding surface portion extending in the circumferential direction so as to protrude outward in the radial direction alternate along the axial direction. The recessed surface portion of the inner circumferential surface 3 is referred to as inner circumference recessed surface portion 31, and the protruding surface portion of the inner circumferential surface 3 is referred to as inner circumference protruding surface portion 32.

The inner circumference recessed surface portion 31 is disposed on the inner side of the corresponding outer circumference recessed surface portion 21 in the radial direction. The inner circumference protruding surface portion 32 is disposed on the inner side of the corresponding outer circumference protruding surface portion 22 in the radial direction.

In the corrugated tubular member 1 of Embodiment 1, a distance between the adjacent outer circumference recessed surface portions 21 is almost constant in the circumferential direction and the axial direction, and a distance between the adjacent outer circumference protruding surface portions 22 is almost constant in the circumferential direction and the axial direction. A distance between the adjacent inner circumference recessed surface portions 31 is almost constant in the circumferential direction and the axial direction, and a distance between the adjacent inner circumference protruding surface portions 32 is almost constant in the circumferential direction and the axial direction.

In the corrugated tubular member 1 of Embodiment 1, the difference 2L between the recess and the protrusion on the outer surface is 1 mm, and the difference 3L between the recess and the protrusion on the inner surface is 0.5 mm.

The production method of Embodiment 1 will be described below.

The production method of Embodiment 1 includes an extruding step and a molding step.

The extruding step is a step of producing a foam tube material 6 having a straight tube shape. The molding step is a step of molding the foam tube material 6 from an outer circumferential surface 62 side by mold blocks 8 of a corrugator 7, and forming a corrugated surface shape on the outer circumferential surface 62 of the foam tube material 6.

In the extruding step, TPV and foam beads are put into a feeder of a not-illustrated extrusion molding machine, and the straight-tube-shaped foam tube material 6 having a foam material layer 64 is extrusion-molded through a mold of the extrusion molding machine.

The extrusion molding machine is disposed on the upstream side of the corrugator 7, and the foam tube material 6 produced in the extruding step is fed into the corrugator 7 in an uncured state.

As shown in FIG. 3, the corrugator 7 has a plurality of mold blocks 8. The mold blocks 8 each have a half-divided shape, and two mold blocks 8 are combined to form a cavity. The foam tube material 6 is disposed inside the cavity.

The corrugator 7 includes a not-illustrated pressure reducing device. Through holes 80 through which the inside and the outside of the cavity communicate with each other are formed in the mold blocks 8. The pressure reducing device is connected to the through holes 80, and reduces pressure in the cavity. The mold blocks 8 are heated, and the foam tube material 6 in the cavity is softened and becomes deformable.

When the pressure in the cavity is reduced by the pressure reducing device, the foam tube material 6 in the cavity is pressed against a mold surface 81 of the mold block 8 while the foam tube material 6 is being foamed. Thus, a corrugated surface shape is formed on the outer circumferential surface 62 of the foam tube material 6. By cooling and curing the foam tube material 6, the corrugated tubular member 1 of Embodiment 1 having the corrugated surface shape on the outer circumferential surface 2 is obtained.

In the molding step, the inner circumferential surface 3 of the foam tube material 6 follows the outer circumferential surface 2 and is drawn toward the mold surface 81. Therefore, a corrugated surface shape is also formed on the inner circumferential surface 3 of the foam tube material 6. Thus, in the corrugated tubular member 1 of Embodiment 1, the corrugated surface shape is also formed on the inner circumferential surface 3.

In the production method of Embodiment 1, the expansion ratio of the corrugated tubular member 1 is 1.5 times. In other words, the volume of the corrugated tubular member 1 is 1.5 times the volume of the foam tube material 6.

The mold blocks 8 and the foam tube material 6 move relative to each other in the axial direction of the foam tube material 6. Therefore, the foam tube material 6 is sequentially molded along the axial direction by the mold blocks 8, and the corrugated tubular member 1 having a large length is obtained.

The corrugated tubular member 1 of Embodiment 1 has the corrugated surface shape on each of the outer circumferential surface 2 and the inner circumferential surface 3, and is formed of foamed TPV, and is thus elastically bendable and deformable.

In the corrugated tubular member 1 of Embodiment 1, the difference 3L between the recess and the protrusion on the inner surface is less than the difference 2L between the recess and the protrusion on the outer surface. Therefore, in the corrugated tubular member 1 of Embodiment 1, increase of pressure loss of a fluid in the tube inside 10 is inhibited, and furthermore, the corrugated tubular member 1 has the corrugated surface shape on the outer circumferential surface 2 and is easily bendable and deformable.

Furthermore, the corrugated tubular member 1 of Embodiment 1 has a monolayer structure formed merely of the foamed layer 4, and the entirety of the corrugated tubular member 1 including the outer circumferential surface 2 and the inner circumferential surface 3 in the thickness direction is integrally molded. Therefore, the corrugated tubular member 1 of Embodiment 1 is molded by a standard corrugator 7 unlike the corrugated tubular member having a double-tube structure as described above.

Thus, in the production method of Embodiment 1, the corrugated tubular member 1 that inhibits increase of pressure loss is produced at low cost. Furthermore, the corrugated tubular member 1 of Embodiment 1 allows increase of pressure loss to be inhibited and is produced at low cost.

### Embodiment 2

A corrugated tubular member 1 of Embodiment 2 is different from the corrugated tubular member 1 of Embodiment 1 in that the corrugated tubular member 1 of Embodiment 2 has a two-layer structure and has an inner circumferential surface 3 having a different shape. The corrugated tubular member 1 of Embodiment 2 and the corrugated tubular member 1 of Embodiment 1 are substantially the same in the other configuration. Hereinafter, the corrugated tubular member 1 and a method for producing the corrugated tubular member 1 according to Embodiment 2 will be described by mainly describing the difference from the corrugated tubular member 1 of Embodiment 1.

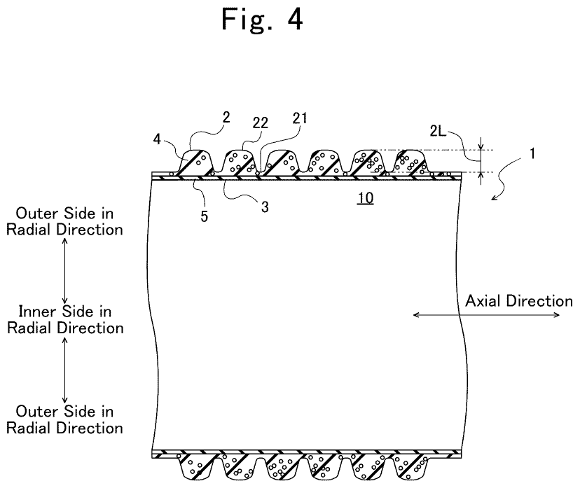

FIG. 4 schematically illustrates a cross-section of the corrugated tubular member 1 of Embodiment 2

As shown in FIG. 4, the corrugated tubular member 1 of Embodiment 2 has a two-layer structure in which a solid layer 5 is formed on the inner side of the foamed layer 4 in the radial direction.

The solid layer 5 is formed of non-foamed PP.

In the corrugated tubular member 1 of Embodiment 2, a corrugated surface shape is formed on the outer circumferential surface 2 while the inner circumferential surface 3 is flat and does not have a corrugated surface shape.

In the corrugated tubular member 1 of Embodiment 2, the difference 2L between the recess and the protrusion on the outer surface is 1 mm.

In the production method of Embodiment 2, a foam tube material having a two-layer structure that has a foam material layer on the outer side in the radial direction and a solid material layer on the inner side in the radial direction is extrusion-molded in the extruding step by a method called two-color extrusion molding or co-extrusion molding.

More specifically, in the extruding step, a material of the foam material layer and a material of the solid material layer in the foam tube material are separately put into a feeder of a not-illustrated extrusion molding machine. Then, a straight-tube-shaped foam tube material having the foam material layer and the solid material layer is extrusion-molded through a mold of the extrusion molding machine.

The above-described foam tube material is fed to a corrugator, and the corrugated tubular member 1 of Embodiment 2 is molded in substantially the same procedure as that in the molding step of the production method of Embodiment 1.

In the production method of Embodiment 2, the expansion ratio of the foamed layer 4 is 1.5 times, and the solid layer 5 is not foamed. The expansion ratio of the solid layer 5 is considered to be 1.0 time.

The corrugated tubular member 1 of Embodiment 2 has the corrugated surface shape having the outer circumference recessed surface portion 21 and the outer circumference protruding surface portion 22, merely on the outer circumferential surface 2, and does not have a corrugated surface shape on the inner circumferential surface 3. However, since the corrugated tubular member 1 of Embodiment 2 has the corrugated surface shape on the outer circumferential surface 2, the foamed layer 4 is formed of foamed TPV, and the solid layer 5 is also formed of PP which is deformable, the corrugated tubular member 1 of Embodiment 2 is also elastically bendable and deformable.

The corrugated tubular member 1 of Embodiment 2 substantially has no difference between the recess and the protrusion on the inner surface. Therefore, the corrugated tubular member 1 of Embodiment 2 also allows increase of pressure loss of a fluid in the tube inside 10 to be inhibited, and furthermore, has the corrugated surface shape on the outer circumferential surface 2 and is easily bendable and deformable.

Furthermore, although the corrugated tubular member 1 of Embodiment 2 has a two-layer structure having the foamed layer 4 and the solid layer 5, the foamed layer 4 and the solid layer 5 are integrally molded. Therefore, the entirety of the corrugated tubular member 1 including the outer circumferential surface 2 and the inner circumferential surface 3 in the thickness direction is considered to be integrally molded. Therefore, the corrugated tubular member 1 of Embodiment 2 is also molded by a standard corrugator.

Thus, the production method of Embodiment 2 allows the corrugated tubular member 1 that inhibits increase of pressure loss to be produced at low cost. Furthermore, the corrugated tubular member 1 of Embodiment 2 inhibits increase of pressure loss and furthermore, is produced at low cost.

Although the present disclosure has been described above, the present disclosure is not limited to the above-described embodiments and the like, components described in the embodiments and the like may be extracted and combined as appropriate to carry out the present disclosure, and various modifications may be made without departing from the gist of the present disclosure.

In addition, the specification of the present disclosure discloses not only the technical concept according to the citation relationship of the claims as originally filed, but also the technical concept obtained by combining the matters recited in the claims as appropriate.

1. A corrugated tubular member comprising
a tubular member having a tubular shape, the tubular member being elastically bendable and deformable, wherein
a corrugated surface shape in which a recessed surface portion extending in a circumferential direction so as to be recessed inward in a radial direction, and a protruding surface portion extending in the circumferential direction so as to protrude outward in the radial direction alternate along an axial direction is formed on an outer circumferential surface,
at least a part of the corrugated tubular member in the radial direction is formed as a foamed layer,
an entirety of the corrugated tubular member including the outer circumferential surface and an inner circumferential surface in a thickness direction is integrally molded, and
the following element (a) or (b) is satisfied,
(a) the corrugated surface shape is formed also on the inner circumferential surface in addition to the outer circumferential surface, and
a difference between a recess and a protrusion in the radial direction in the corrugated surface shape on the inner circumferential surface is less than a difference between a recess and a protrusion in the radial direction in the corrugated surface shape on the outer circumferential surface, or
(b) the inner circumferential surface does not have the corrugated surface shape.

2. The corrugated tubular member according to claim 1, wherein
the element (a) is satisfied,
the difference between the recess and the protrusion in the radial direction in the corrugated surface shape on the outer circumferential surface is 1 mm or more, and
the difference between the recess and the protrusion in the radial direction in the corrugated surface shape on the inner circumferential surface is 0.5 mm or less.

3. The corrugated tubular member according to claim 1, wherein a solid layer is formed on an inner side of the foamed layer in the radial direction.

4. The corrugated tubular member according to claim 1, wherein a material of the foamed layer contains a thermoplastic elastomer.

5. A method for producing the corrugated tubular member according to claim 1, the method comprising a molding step of molding a foam tube material having a straight tube shape from an outer circumferential surface side by a mold block of a corrugator, and forming the corrugated surface shape on the outer circumferential surface of the foam tube material.

6. The method for producing the corrugated tubular member according to claim 5, wherein
at least a part of the foam tube material in the radial direction includes a foam material layer which is foamed in the molding step and formed into the foamed layer, and
an expansion ratio of the foamed layer is 1.5 times or more.

7. The method for producing the corrugated tubular member according to claim 5, wherein the foam tube material has a multilayer structure having a foam material layer on an outer side in the radial direction, and a solid material layer on an inner side in the radial direction.
